(19) United States
(12) Patent Application Publication
(10) Pub. No.: US 2007/0077400 A1
(43) Pub. Date: Apr. 5, 2007

(54) Method of producing printed business communication laminates from dissimilar substrates having different thicknesses and products produced therefrom

(75) Inventor: Jesse D. Crum, St. Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/243,738

(22) Filed: Oct. 5, 2005

(51) Int. Cl. B44C 1/17

(52) U.S. Cl. 428/195.1

(57) ABSTRACT

The present invention is directed toward a business communication laminate that is constructed from at least two layers having significantly distinct thicknesses. The first layer is provided with printing or imaging having a resolution of greater than about 150 lines per inch. Through preparation of the laminate in accordance with the present invention, high quality graphics and imaging can be applied to materials, such as thick corrugated substrates, to create effective business communication substrates and marketing collateral.

### CROSS-REFERENCES TO RELATED APPLICATIONS

None.

### FIELD OF THE INVENTION

The present invention is in the field of prepared, printed laminates that are used in the preparation of business communications, marketing platforms, advertising pieces and the like. More particularly the instant specification is directed toward the creation of laminates that are created by initially printing a first film stock that has a relatively thin thickness and is prepared with high resolution graphics, and then, preferably permanently laminating the first printed film stock onto a second stock of material that may be roughly equal to or substantially thicker than the first film stock.

A third stock may be applied to the second stock opposite to the first material to create desirable visual displays on both faces of the substrate. The laminate that is prepared in accordance with the present invention may then be used in a wide variety of applications and is intended to supplant materials that heretofore could only be produced using relatively few colors and at a low image resolution due to inherent limitations in conventional printing and manufacturing equipment.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and new information handling needs of businesses and consumers alike.

However, while printed products, such as pieces and other assemblies that are intended to be used in business communications, can be delivered in a wide variety of formats, constructions and configurations, the manufacturing of such diversified products may simply be unattainable by most producers of such products, particularly smaller sized manufacturers.

Typically, one of the most significant limiting factors for a manufacturer in being able to produce a particular construction or expand product capabilities is the available equipment the manufacturer has on hand or which may be available on the market to generate such printed pieces. Such forms handling machinery and other printing apparatus even if available for acquisition can be quite expensive and in addition the equipment may require some customization before the equipment can be integrated into a particular manufacturing processes. Thus, egress into new product categories may simply not be possible due to cost constraints.

Equipment may be further limited by the type of stocks or substrates that can be effectively handled or processed by such presses thereby further limiting the potential output of the types of products from manufacturers. For example, board or tag stocks are exemplary materials that due to the thickness of the substrate cannot be handled by most types of equipment and thus cannot printed upon by such conventional printing technologies as flexographic.

Flexography is one exemplary conventional technology that is commonly used today for the printing of decorative items, because of the ability to print multiple colors. However, flexography is one exemplary technology that suffers from the foregoing drawbacks.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

The market for printed communication material is also changing and becoming more sophisticated. Such conventional business forms manufacturers have normally produced product runs that range in the hundreds of thousands to millions or even tens of millions of pieces for a single order. These single orders may be produced for example in connection with a multiple part medical form product, insurance form or the like. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs or orders sizes, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms and labels, may also be limited in the type of jobs that a manufacturer will accept. These additional factors may include the size of the job, or more particularly the order quantity or value of the order. That is, due to cost factors, a customer will not place an order with a manufacturer for a small to medium quantity of pieces as the set up or make ready of the job makes the order cost prohibitive, even assuming that the manufacturer would accept the order if a particular price could be obtained to justify production.

A still further drawback of trying to migrate to smaller customer applications relates to quality of the pieces that need to be generated. With the focus of the market slowly shifting to smaller runs, the end user is now demanding a greater image quality than that typically associated with conventionally printed products. It is believed that one of the reasons for such far reaching changes is that budgets for marketing and business communications have been cut back in recent years and as such, end users want more from each piece that is produced rather than relying on the quantity of pieces to generate the desired result. In addition, marketers want to make a greater impact at every turn in the retail chain to try and maximize the chances for purchases of a particular product being offered.

With the change in focus to quality as opposed to quantity there are a number of products that to date are still out of reach of conventional manufacturers in that certain materials are simply to thick or unwieldy to be able to be handled by printing equipment and forms processing apparatus.

In addition, with the rise of consumer oriented warehouses, superstores, shopper's and price clubs, discount chains, “big box retailers” and the like, many products that are intended for retail or consumer use are never removed from their shipping package or container. Instead, these relatively bland packages are placed on pallets on the floor or on shelves and the consumer merely load the package into his or her cart and then remove the goods from the package upon arrival at one's home. Thus, such conventional packaging does little in the way of marketing or encouraging point of sale type activity to entice a consumer to purchase one product over another. In this age of brand marketing, and positioning of products in the consumer focus, so much of the effort associated with advertising and marketing to the consumer is then lost, as the package does not necessarily complete the image that the manufacturer of the consumer good wishes to convey to prospective customers.

While some cartons may have printed sheets providing a picture of the product applied exteriorly to the carton, those sheets do not typically cover the face of the side of the carton to which the sheet has been applied and may in fact detract from the quality of the product. In addition, it often appears as if the sheet was applied post packaging, which is in fact typically the situation. In such instances, the sheets can appear splayed or crooked on the surface, may bubble up due to incomplete lamination or sloppy application of the sheet to the carton, may rip or tear upon handling during shipping or simply be removed from the exterior of the carton thereby defeating the purpose of applying the sheet. As such, a more effective and aesthetically appealing point of sale vehicle is needed for such bulk retail applications.

Thus, what is needed is a laminated packaging construction that provides conventional manufacturers of business communication products with the ability to produce attractive and effective business communication laminates that may be used in preparing relatively thick stocks of material with high quality graphics and then preferably permanently laminating the thin material to a thicker base stock thereby creating enhanced marketing platforms.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unexpectedly, it has been found that relatively thick materials, such as corrugated substrates, heavy board and tag stocks and the like have heretofore not been produced with high quality graphics due to limitations inherent in conventional manufacturing equipment. The present invention is directed toward a novel construction that enables the printing of relatively thin materials so as to obtain significantly improved graphics and imaging quality. These materials may then be laminated on to thicker base substrates to create enhanced marketing platforms in an effort to improve the aesthetic attributes of the consumer offering. The preparation of printed laminates in the fashion described in the present invention enables conventional business forms manufacturers to provide customers with a highly attractive product that may be utilized in areas not previously served by high end graphic products. It should be understood, that the invention can be used in connection with variously sized stocks ranging from thin stocks to relatively thick stocks ranging to several times the thickness of the first stock.

In one exemplary embodiment of the presently described invention, a high resolution printed business communication laminate produced from dissimilar thickness materials is described and includes a first printable material that has a thickness ranging from about 0.01 mils to approximately about 4 mils. The printable material has first and second faces with at least printing that has a resolution of greater than about 150 lines per inch applied to the first face.

A second material is provided in connection with the presently described embodiment and has a thickness of greater than about 4 mils, the second material has first and second faces. A pattern of pressure sensitive adhesive is applied to the first face of the second material. The first printable material second face is placed in substantial juxtaposition with the first face of the second material over the pattern of adhesive to create an adhesively bonded laminated business communication piece that has a total thickness of greater than about 4.02 mils and the piece is formed to create a package suitable for use in a bulk retail application.

In a still further exemplary embodiment of the present invention, a method of producing a high resolution printed business communication laminate, is presented and includes the steps of, initially providing a first substrate, with the first substrate having first and second faces and a first thickness. Printing is provided on at least the first face of the first substrate with an image resolution of greater than about 150 lines per inch.

Continuing with a discussion of the presently described embodiment, a second substrate is provided, with the second substrate having first and second faces and a second thickness that is at least twice as much as the first thickness. Next, a pattern of adhesive is applied to at least the first face of the second substrate. The second face of the first substrate is then placed in contact with the first face of the second substrate, and then the first substrate is sealed, preferably permanently, to the second substrate to create a business communication laminate that is then formed to create a package suitable for use in a bulk retail application.

In a yet still further exemplary embodiment of the present invention, a high resolution printed business communication laminate is produced in accordance with the following method that includes the steps of, initially preparing a first substrate. The first substrate has first and second faces and a first thickness. The first substrate has imaging applied to one of the first and second faces with the imaging having a resolution of greater than about 150 lines per inch. Next, a second substrate is provided that has a second thickness that is at least two times greater than the first thickness. The second substrate has first and second faces and a pattern adhesive applied to the first surface. The first substrate is juxtapositioned on the second face substantially over the first face of the second substrate to create a temporary business communication intermediate laminate that is then folded to create a bulk retail package.

In connection with the foregoing embodiments, a third substrate or material may be provided and adhered by a pattern of adhesive to the second face of the second substrate to create a dual sided communication piece. In addition, either the first or third layers may be transparent or translucent and the printing applied, in a reverse or mirror format such that the imaging can be read through the transparent layer when the layer is applied to the substrate.

The laminate that is prepared in accordance with the forgoing embodiments may also be cut into any number of shapes or configuration to fit the needs of the end user or customer.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a side elevation of an exemplary laminate prepared in connection with the present invention;

FIG. 2 shows an alternative embodiment of a side elevation of an exemplary laminate prepared in connection with the present invention;

FIG. 3 provides a bulk retail package prepared in accordance with the present invention from a laminate;

FIG. 4 illustrates a further alternative for a layer used in preparing a laminate showing a transparent or translucent film with reverse printing; and

FIG. 5 depicts a block diagram setting forth and exemplary method of practicing the present invention to create a laminate to form a bulk retail package.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

With the rise of large consumer goods outlets such as big box retailers, warehouse and shoppers clubs and the like, a need has developed to create an effective package that will stimulate sales of products while the product remains in its shipping or packaging container. Such packages need to be created in an integrated fashion to overcome the drawbacks identified above and the manufacturer of such products needs to be able to leverage the latest in high resolution imaging technology that heretofore has not been available for such applications.

The inventors of the instant specification have discovered that such a package can be created through novel application of multiple technologies to create an advanced pacakge design. The present invention is used in preparing a business communication piece in either an intermediate form or one that is suitable for immediate use or application, such as in a package for bulk retail application. The invention utilizes high resolution imaging technology to prepare a first substrate or material with high quality graphics and then the first substrate s laminated, preferably permanently, to a second or base substrate. The substrates that are used in connection with the manufacture of the laminate preferably have significantly different thicknesses, with the second substrate or base material having a thickness that is at least two times that of the first substrate and likely three or more times the thickness of the first substrate or material.

The laminate prepared in connection with the present invention may find use in a number of applications, such as packaging for consumer products, including those corrugated packages that are commonly used for electronics, home and office products, house wares and the like. The present invention finds its particular niche in preparing packaging for large retail outlets such as “big box” retailers, warehouse and shopper's clubs and the like.

As used herein the term “business communication” is used to refer to a printed or imaged piece, document or substrate that when used as a laminate as described in the present invention will convey a particular message, image or provide information about a particular product or service that is available from the provider of such pieces or documents. Business communication laminates, documents or pieces can include advertising, sales and marketing collateral and such other items used to convey information.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering and the like. Typically, a product such as with the present invention is provided in an intermediate condition so that a user or downstream manufacturer can add or manipulate the intermediate to create the final or desired end product, such as creating a carton or the like. Thus, in accordance with the present invention, the intermediate segment for example, could be subject to die cutting or additional printing, such as through ink jetting, over laminating, coating or embossment, and then applied to a container, carton, consumer package good or the like.

The phrase “bulk retail applications” refers to consumer outlets such as warehouse clubs, shopper's clubs, large retail stores, “big box” stores, superstores, price clubs, discount chains and combinations thereof where members of the general public may enter either with or without membership credentials.

Printable substrates are normally purchased in accordance with its weight per unit area. The area is normally that of a 500 sheet ream cut to a specified sized (“ream size”). For example, if a certain grade of paper has a specified ream size of 17 ×22 inches, the actual weight of 500 sheets in that size is the basis weight. A sheet with a 20 pound basis weight may be identified as 20-lb. or 20# and is customarily used in desktop printers and office use. Heavier bonds such as vellum may range from 60 to 80 pounds, Bristol board from 90 to 100 bounds and tag stock for example from 80 to 110 pounds and higher.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

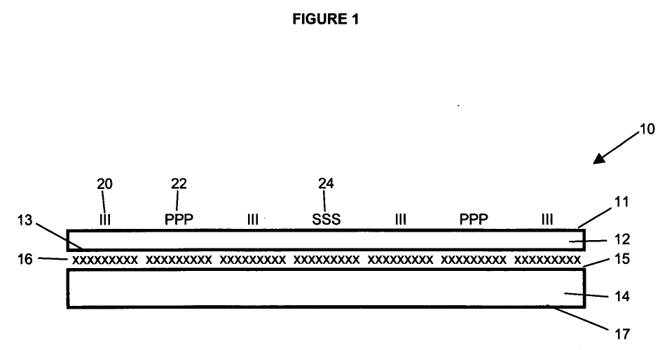

Reference is now directed to FIG. 1 of the present invention which shows an exemplary laminate 10 in an intermediate condition. The laminate 10 includes a first substrate or material 12 and a second substrate or material 14 which will serve principally as the base or core, where additional layers may be added such as to the reverse side of the second substrate 14 of the laminate 10 as will be described herein.

It should be understood that each of the first and second substrates or materials will include first and second longitudinally extending sides and first and second transversely extending edges. Each material or laminate will also have first and second sides or faces as will be described herein.

The first substrate 12 is prepared in advance of creating the laminate and is processed through a high quality, high resolution imaging device by printing on one of the first and second faces. The first substrate 12 is then cut to size, if necessary to fit on the area of the second substrate 14.

A pattern of adhesive 16 is applied to the first face 15 of the second substrate 14. The second substrate also has second face 17. The first substrate second face 13 is brought into contact with the pattern of adhesive 16 so as to permanently secure the first substrate 12 to the second substrate 14 to create the laminate 10.

Also as shown in FIG. 1, the first face 11 of first substrate 12 is provide imaging 20, represented by the letter “I” in the drawing, personalized printing 22, represented by “P” in the drawing, and static or fixed printing 24, represent by the letter “S” in the drawing. The printing and imaging will preferably be accomplished by a high resolution imaging device such as that available from KBA and sold under the name Karat as described above.

The first layer 12 is preferably of a relatively thin stock of material and generally will be less than about 4 mils in thickness. The material may be a cellulosic based material such as paper or may include a synthetic film (e.g. PET, polycarbonate, and the like) or a metal foil (e.g. aluminum). The second substrate 14 will be significantly thicker than the first material 12 and may be two, three, four or more times the thickness of the first layer and will be at least 4 mils or greater in thickness. An exemplary material that is suitable for preparation of the laminate depicted in FIG. 1 is a corrugated material such as cardboard, however, other stocks of material such as board stock, vellum, tag stock and the like may be used.

The laminate of the present invention may be created in a continuous fashion, that is once the first material or substrate is printed or imaged it is then substantially immediately applied to the second substrate or material, such as by merging the two substrates together. Alternatively, the first sheet or material can be prepared in advance and then supplied to a second station or location at a later date and the first sheet joined to the second material or substrate. The second station or location can be at the same site or may be at a distinct site such as two different manufacturing companies.

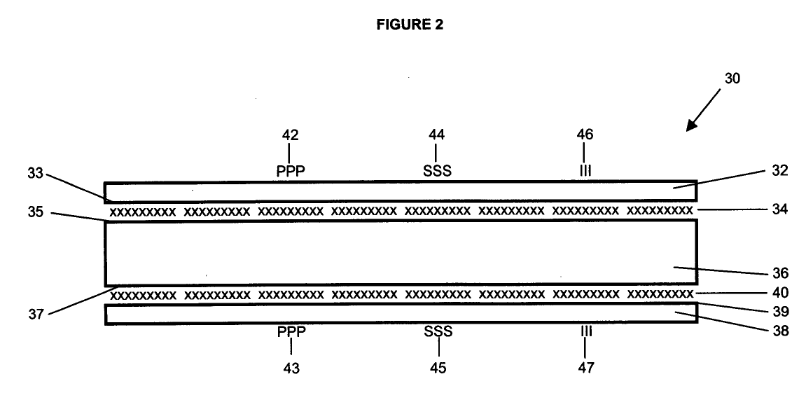

FIG. 2 provides an alternative laminate configuration 30 that may be used as an intermediate for forming a bulk retail package. The laminate 30 shown in FIG. 2 has a first layer or substrate 32 that is secured by a pattern of adhesive 34 to a second layer or substrate 36. The second face 33 of the first layer 32 is juxtapositioned so as to be aligned with the first face 35 of the second layer 36. That is, the first and second transversely extending edges and first and second longitudinally extending sides are aligned with one another. This configuration will typically follow, regardless of whether the base substrate or core is provided with one or more printed layers.

FIG. 2 also provides that the first face 37 of third layer 38 is secured to the second face 35 of the second layer 36 by a pattern of adhesive 40. Each of layers 32 and 38 may be printed with personalized information 42 and 43, respectively, and represented by the letter “P” in the drawing; static printing 44 and 45, respectively, and represented by the letter “S” in the drawing; and imaging 46 and 47, respectively, and represented by the letter “I” in the drawing. The printing and/or imaging on layers 32 and 38 may be related or match one another so that the message and image is consistent on each side of the laminate or alternatively, each of the layers may contain imaging or printing that is distinct from that which appears on the other side of the substrate 36. For example, the first layer 32 may form the out layer of the bulk retail package and the third layer 38 may contain the interior of the package. On the exterior of the packaging advertising and other general information may be applied. On the interior, specific instructions may be printed such as assembly or start up as well as other permutations such as sweepstakes or prize information, return information and the like.

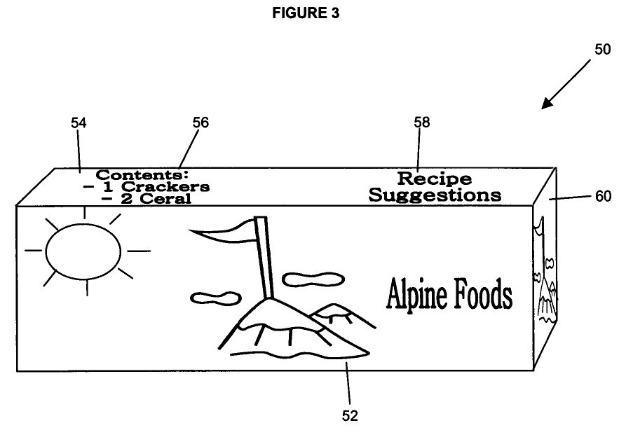

FIG. 3 provides a view of a retail package 50 intended to be used in bulk retail applications such as warehouse clubs, shopper's clubs, large retail stores, “big box” stores, superstores, price clubs, discount chains and combinations thereof. In this FIG. 3, the laminate prepared either in accordance with the depictions in FIGS. 1 and/or 2 have been used to form the retail package 50. The face of the package 52 has been printed with graphics and textual information. The top of the package 54 has been provided with personalized and static printing 56 and 58, respectively. The remaining visible side 60 of the package 50 has also been printed with graphics and textual information. By using the laminate prepared in connection with the present invention, a highly attractive package can be created that accentuates the marketing message and branding theme as opposed to the relatively drab conventional packages that may be used in such bulk retail applications.

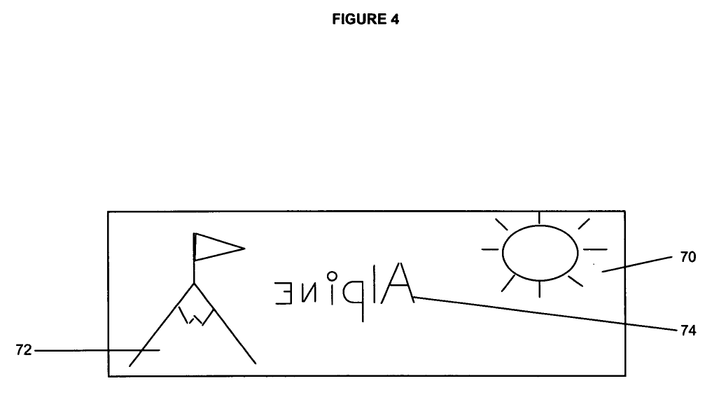

FIG. 4 is used to illustrate a further embodiment of the present invention in which a layer 70 may be transparent, substantially transparent or translucent. The substrate, which again will be of a relatively thin material warehouse clubs, shopper's clubs, large retail stores, “big box” stores, superstores, price clubs, discount chains and combinations thereof al has been provided with imaging 72 and textual information 74. The textual information 74 has been reverse printed so that when the layer 70 is placed on a core of base substrate as shown in FIGS. 1 and 2 the textual information will be visible through the material or layer.

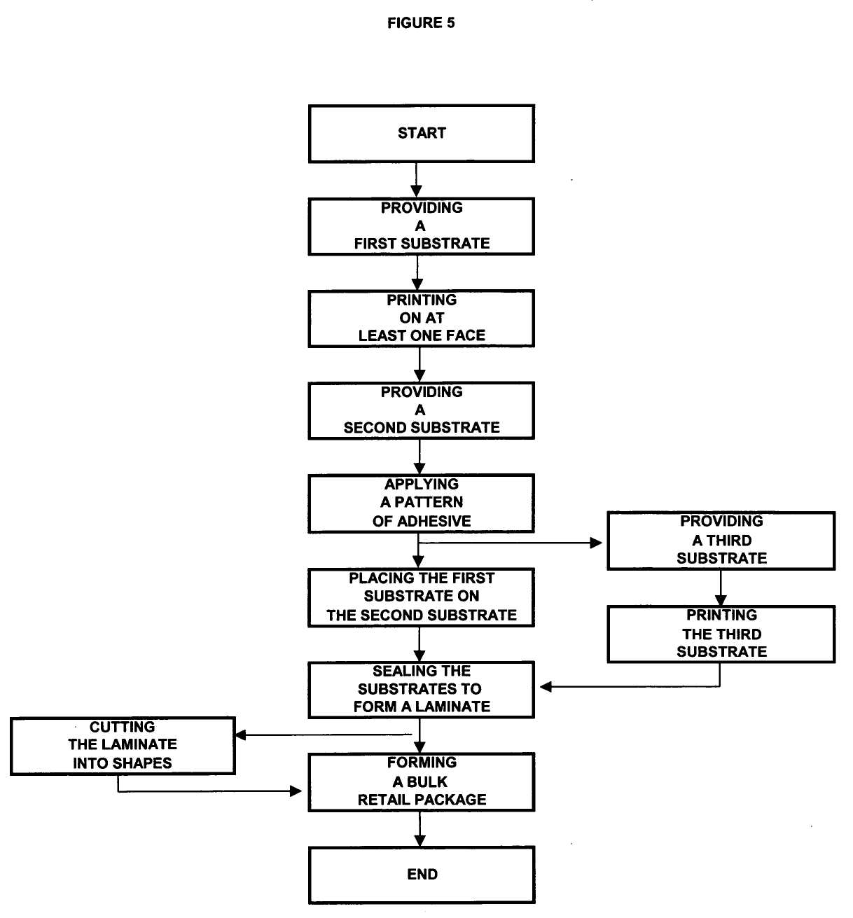

Reference is now directed to FIG. 5 which provides an exemplary block diagram that is used in practicing the present invention. Once the process is initiated such as by the receipt of an order from a customer, a first substrate is provided at step 100. The substrate will preferably have a thickness of less than 4 mils and will be easily processed through high resolution imaging equipment. The substrate will be one that readily adapts to receiving printing and may also be coated with a toner or ink receptive coating to aid in anchoring the toner or ink to the substrate.

Next, printing is applied to at least one face at step 110. As previously described, the printing will preferably be provided at a resolution of greater than about 150 lines per inch and preferably more than 300 lines per inch, which is approximately equal to about 2500 to 3500 dots per inch (“DPI”) in order to create a high quality image that is intended to be aesthetically appealing to the consumer.

A second substrate is provided at step 120. The second substrate will preferably be significantly thicker than the first material, and in an exemplary embodiment the second substrate may be a corrugated material that is commonly used in packaging consumer products.

Next, a pattern of adhesive is applied to the first face of the second substrate at step 130 and the second face of the first substrate is brought into contact with the adhesive at step 140. Once the two substrates are in position, the substrates are sealed at step 150 to one another at step 150 to preferably create a permanent bond that will prohibit the first and second substrates from separating from one another during subsequent handling such as may occur during shipment of the package. Finally, the laminated that is prepared by sealing the two layers together is formed into a bulk retail package at step 160. The forming may occur by folding the laminate into a box or other package to hold the consumer products intended for shipment.

In alternate embodiments, a third substrate may be provided at step 135. The third substrate will preferably be of an equivalent material and thickness to the material used as the first substrate. However, it should be understood that any other suitable material that is printable may be employed. The third substrate undergoes printing at step 137 which preferably with be a high resolution, quality printing.

The laminate of the present invention may be prepared in a number of widths and lengths and as such it may be necessary to cut the laminate into individual sheets, shapes or other lengths at step 155.

The sheets or shapes may then be collected and formed into the bulk retail package as described above at step 160.

In accordance with the present invention, a bulk retail package can be created through the use of the novel laminate and provide the manufacturer with an interesting and unique platform by which to increase point of sale activity and potentially grow sales of the product.

The invention can be used in preparing laminates of varying thicknesses. That is, while the invention may be preferably used to create high color graphics out of relatively thick materials which had not necessarily been previously possible, it can also be used in creating diversified laminates, laminates of relatively equal thicknesses, laminates having one layer significantly less than another or substantially different in order to achieve various laminate configurations.

It will thus be seen according to the present invention a highly advantageous method of producing printed laminates has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A high resolution printed business communication laminate produced from dissimilar thickness materials for use in bulk retail applications, comprising;
a first printable material having a thickness ranging from about 0.01 mils to approximately about 4 mils, said printable material having first and second faces with at least printing having a resolution of greater than about 150 lines per inch applied to said first face;
a second material having a thickness greater than about 4 mils, said second material having first and second faces;
a pattern of pressure sensitive adhesive applied to said first face of said second material; and
wherein said first printable material second face is placed in substantial juxtaposition with said first face of said second material over said pattern of adhesive to create an adhesively bonded laminated business communication piece that has a total thickness of greater than about 4.02 mils and said business communication piece is for a package for bulk retail applications.

2. A printed business communication laminate as recited in claim 1, wherein said second thickness is substantially different than said first thickness.

3. A printed business communication laminate as recited in claim 1, wherein a third material is provided and has a third thickness less than said second thickness and approximately equal to said first thickness.

4. A printed business communication laminate as recited in claim 1, wherein said first material is transparent or substantially translucent and printing is provided on said second face so as to be visible through said first material.

5. A printed business communication laminate as recited in claim 3, wherein said third material second face is provided with printing having a resolution of greater than about 150 lines per inch.

6. A printed business communication laminate as recited in claim 1, wherein said second material is a corrugated board stock material.

7. A printed business communication laminate as recited in claim 1, wherein said first material has first and second longitudinal sides and said second material has first and second longitudinal sides that are substantially in alignment with said first and second longitudinal sides of said first material.

8. A printed business communication laminate as recited in claim 7, wherein said printing on said first material is provided between said first and second longitudinal sides.

9. A printed business communication laminate as recited in claim 1, wherein said bulk retail applications are selected from a group including warehouse clubs, shopper's clubs, large retail stores, superstores, discount chains, price clubs and combinations thereof.

10. A method of producing a high resolution printed business communication laminate suitable for use in bulk retail applications, comprising the steps of;
providing a first substrate, said first substrate having first and second faces and having a first thickness;
printing on at least said first face of said first substrate with an image resolution of greater than about 150 lines per inch;
providing a second substrate, said second substrate having first and second faces and a second thickness that is at least twice as much as said first thickness;
applying a pattern of adhesive to at least said first face of said second substrate;
placing said second face of said first substrate in contact with said first face of said second substrate;
sealing said first substrate to said second substrate to create a business communication laminate; and
forming said business communication laminate into a package for bulk retail applications.

11. A method as recited in claim 10, including a step of providing a third substrate having first and second faces and having a third thickness that is less than said second thickness of said second substrate and adhering said third substrate first face to said second substrate second face by a pattern of adhesive at any time after the step of providing said first substrate.

12. A method as recited in claim 11, including a further step of printing on said third substrate second face after the step of providing said third substrate.

13. A method as recited in claim 10, including a further step of cutting said laminate after the step of sealing.

14. A method as recited in claim 10, wherein said step of sealing creates a permanent bond between said first material and said second material.

15. A high resolution printed business communication laminate produced in accordance with the following method comprising the steps of;
preparing a first substrate, said first substrate having first and second faces and having a first thickness, said first substrate having imaging applied to one of said first and second faces with said imaging having a resolution of greater than about 150 lines per inch;
providing a second substrate having a second thickness that is at least two times greater than said first thickness, said second substrate having first and second faces and a pattern adhesive applied to said first surface;
juxtapositioning said first substrate second face substantially over said first face of said second substrate to create a temporary business communication intermediate laminate; and
folding said intermediate laminate to form a business communication laminate package suitable for use in bulk retail applications.

16. A business communication laminate as recited in claim 15, including a further step of providing a third substrate having first and second faces and a pattern of adhesive applied to said first face so that when said first face of said third substrate is applied to said second face of said second substrate a dual sided laminate is created.

17. A business communication laminate as recited in claim 16, wherein said third laminate has a third thickness that is less than said second thickness and substantially equal to said first thickness.

18. A business communication laminate as recited in claim 15, including a further step of applying personalized information to at least a portion of said first face of said first substrate substantially simultaneously with preparing said first substrate.

19. A business communication laminate as recited in claim 15, including a further step of printing static information to a least a portion of said first face of said first substrate substantially simultaneously with preparing said first substrate.

20. A business communication laminate as recited in claim 15, wherein said bulk retail applications are selected from a group including warehouse clubs, shopper's clubs, large retail stores, superstores, price clubs, discount chains and combinations thereof.
